(19) United States
(12) Patent Application Publication
(10) Pub. No.: US 2010/0151805 A1
(43) Pub. Date: Jun. 17, 2010

(54) RADIO FREQUENCY CIRCUIT

(76) Inventors: Junji KAIDO, Osaka (JP); Kazuki Tateoka, Kyoto (JP); Masahiko Inamori, Osaka (JP); Hirokazu Makihara, Osaka (JP); Shingo Matsuda, Kyoto (JP)

Correspondence Address: MCDERMOTT WILL & EMERY LLP, 600 13TH STREET, NW, WASHINGTON, DC, 20005-3096, US

(21) Appl. No.: 12/539,101

(22) Filed: Aug. 11, 2009

(30) Foreign Application Priority Data
Dec. 12, 2008 (JP) 2008-317046

(51) Int. Cl. H04B 1/04; G05F 3/04

(52) U.S. Cl. 455/127.3; 327/520

(57) ABSTRACT

In a multi-stage amplifier, a power supply circuit and a multiplier perform control so that, when there are manufacturing variations in, for example, inter-stage capacitance, a collector voltage of a stage immediately preceding a final stage is smaller than a collector voltage of the final stage, thereby suppressing variations in AM-PM characteristics.

### CROSS REFERENCE TO RELATED APPLICATION

This application claims priority to Japanese Patent Application No. 2008-317046 filed on Dec. 12, 2008, the disclosure of which including the specification, the drawings, and the claims is hereby incorporated by reference in its entirety.

### BACKGROUND

The present disclosure relates to a circuit configuration of a radio frequency power amplifier used in a mobile communication apparatus or the like. More particularly, the present disclosure relates to a technique of suppressing variations in AM-PM characteristics which occur when there are variations in a device parameter (particularly, a capacitance).

Lower distortion as well as higher output power and higher efficiency are required for power amplifiers used in a mobile communication apparatus, such as a mobile telephone or the like.

Regarding the higher efficiency, a power amplifier generally used in, for example, a mobile telephone of W-CDMA (Wideband Code Division Multiple Access) controls a collector voltage, depending on an output level, in a manner which allows the collector voltage to fall within a range in which distortion characteristics are not degraded, thereby improving power added efficiency. In the case of a multi-stage amplifier, collector terminals are bundled before being connected to a collector voltage control circuit so as to simplify the collector voltage control circuit.

Regarding the lower distortion, a conventional multi-stage amplifier compensates for distortion which is caused by gain compression during high-output power operation, thereby achieving higher power added efficiency and lower distortion characteristics. Specifically, the multi-stage amplifier includes two transistors connected in a cascade fashion. Within a certain range of input power, a change in gain of the preceding transistor cancels a change in gain of the following transistor. In this conventional example, a gain controller controls a base bias current of a bipolar transistor (see U.S. Pat. No. 6,603,351).

### SUMMARY

In the aforementioned conventional example, the base current of the transistor is controlled, and therefore, a gain cannot be controlled with high precision. This is because, in the bipolar transistor, when the base voltage changes, the base current changes exponentially, and therefore, the gain also changes exponentially.

FIG. 1 shows a result of a simulation of gain changes which are obtained when a base voltage Vb is changed and when a collector voltage Vc is changed. The horizontal axis represents voltage changes with respect to a reference voltage, and the vertical axis represents gain changes with respect to a gain at the reference voltage for each case. The simulation was conducted using a HeteroBipolar Transistor (HBT) model, where the reference voltage is 1.2 V during the Vb control and 3.3 V during the Vc control. As can be seen from FIG. 1, gain changes are significantly larger during the Vb control than those during the Vc control.

Therefore, in the aforementioned conventional example, appropriate control of signal distortion cannot be expected, and it is also difficult to prevent distortion from varying due to manufacturing variations in actually manufactured power amplifiers. Therefore, it can be said that the conventional example is a technique which is substantially not suitable for mass production.

An object of the present disclosure is to solve the aforementioned problem that a gain change is too steep to control.

To achieve the object, a radio frequency circuit according to an embodiment of the present disclosure includes a plurality of amplification stages connected in a cascade fashion, and a power supply unit configured to control an output voltage of a final stage of the plurality of amplification stages and an output voltage of a stage immediately preceding the final stage of the plurality of amplification stages. The output voltage of the stage immediately preceding the final stage is set to be smaller than the output voltage of the final stage.

The power supply unit may include a power supply circuit configured to control the final stage, and a multiplier provided between the power supply circuit and the stage immediately preceding the final stage. For example, where there are variations in an inter-stage capacitance, a value of the multiplier is set so that the voltage of the stage immediately preceding the final stage is smaller than the voltage of the final stage.

According to the present disclosure, for example, by controlling a collector voltage of a bipolar transistor included in a multi-stage amplifier, variations in AM-PM characteristics which occur when there are variations in a device parameter (particularly, a capacitance) can be suppressed.

### BRIEF DESCRIPTION OF THE DRAWINGS

FIG. 1 is a diagram for comparing base voltage control with collector voltage control.

FIG. 2 is a block diagram showing a radio frequency circuit according to a first embodiment of the present disclosure.

FIG. 3 is a diagram showing AM-PM characteristics when there are not variations in inter-stage capacitance in the first embodiment of the present disclosure.

FIG. 4 is a diagram showing AM-PM characteristics when there are variations in inter-stage capacitance in the first embodiment of the present disclosure.

FIG. 5 is a diagram for comparing AM-PM characteristics during typical control with AM-PM characteristics during control of the present disclosure, in the first embodiment of the present disclosure.

FIGS. 6A, 6B and 6C are diagrams for describing a principle of suppression of variations in AM-PM characteristics in the first embodiment of the present disclosure.

FIG. 7 is a block diagram showing a radio frequency circuit according to a second embodiment of the present disclosure.

FIG. 8 is a block diagram showing a radio frequency circuit according to a third embodiment of the present disclosure.

FIG. 9 is a block diagram showing a radio frequency circuit according to a fourth embodiment of the present disclosure.

FIG. 10 is a diagram showing changes in output power with respect to input power when there are variations in inter-stage capacitance in the fourth embodiment of the present disclosure.

FIG. 11 is a block diagram showing a mobile communication terminal device according to a fifth embodiment of the present disclosure.

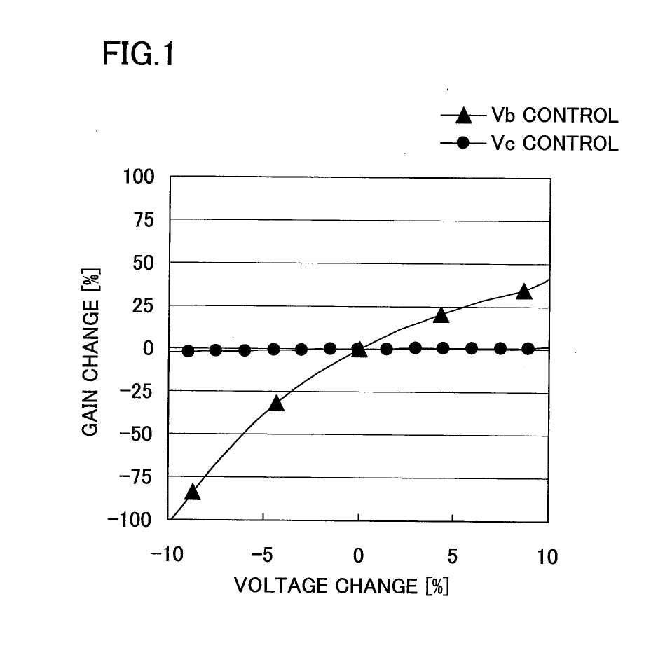

### DETAILED DESCRIPTION

Hereinafter, several examples relating to embodiments of the present disclosure will be described with reference to the accompanying drawings. Note that, in the drawings, components having substantially the same configuration, operation and effect are indicated by the same reference symbols. Numerical values described below are all used to specifically describe the present disclosure, and the present disclosure is not limited to those illustrative numerical values. Moreover, connections between components are used to specifically describe the present disclosure, and connections for achieving functions of the present disclosure are not limited to those. Moreover, embodiments described below are implemented in hardware and/or software. An implementation in hardware can also be achieved in software, and an implementation in software can also be achieved in hardware.

### First Embodiment

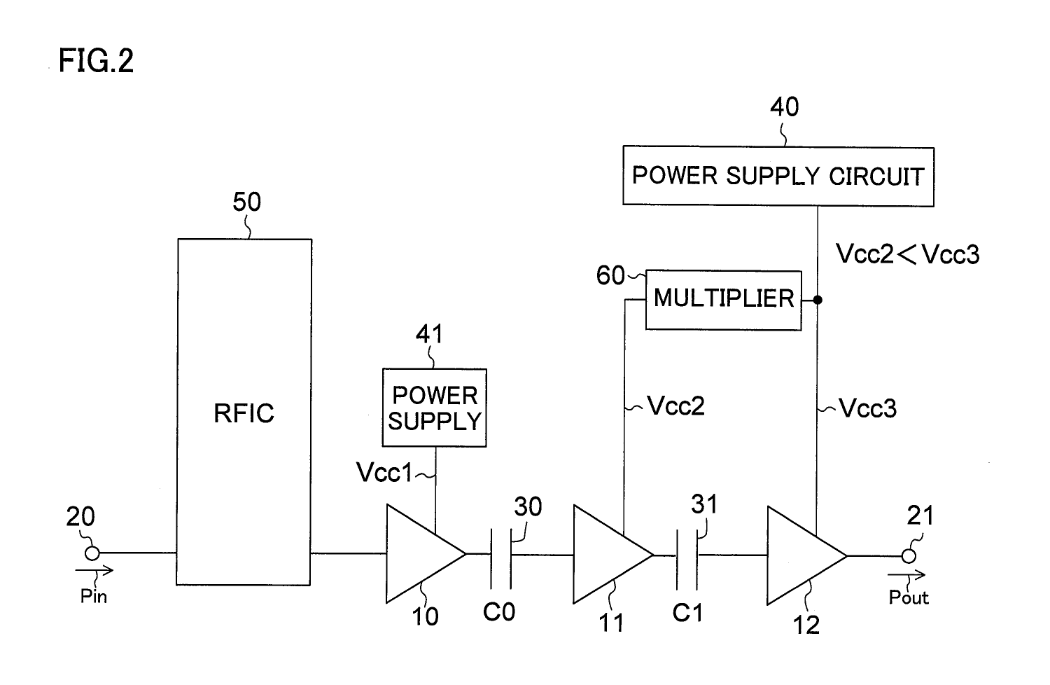

FIG. 2 is a block diagram showing a radio frequency circuit according to a first embodiment. The radio frequency circuit of the first embodiment includes a multi-stage amplifier including a front stage 10, an intermediate stage 11 and a rear stage 12, an input terminal 20, an output terminal 21, a front-intermediate stage capacitor 30, an intermediate-rear stage capacitor 31, an intermediate stage and rear stage control power supply circuit 40, a front stage control power supply 41, a modulation RFIC 50, and a multiplier 60. The front-intermediate stage capacitor 30 has a capacitance value of C0 [pF], the intermediate-rear stage capacitor 31 has a capacitance value of C1 [pF], the front stage 10 has a fixed voltage of Vcc1 [V], the intermediate stage 11 has a control voltage of Vcc2 [V], and the rear stage 12 has a control voltage of Vcc3 [V].

Although a general radio frequency circuit is used where Vcc2=Vcc3, the multiplier 60 of the present disclosure is designed so that Vcc2<Vcc3, thereby suppressing variations in AM-PM characteristics which occur when there are variations in the inter-stage capacitances C0 and C1. Typically, the multiplier 60 is designed so that Vcc2=Vcc3×0.8. The value of the control voltage Vcc3 has a significant influence on the maximum output, and therefore, is set to satisfy a voltage condition under a general condition of use (typically, Vcc3=3.3 V). Here, the AM-PM characteristics refer to a relationship between an output power (Pout) and a phase (Phase) at the output terminal 21.

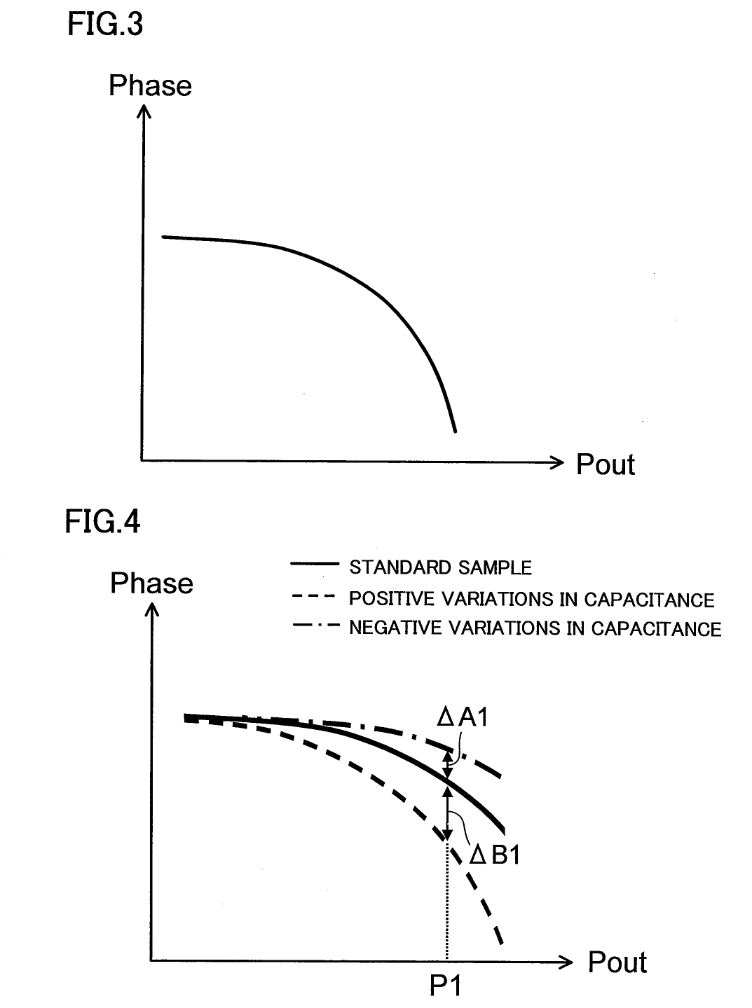

An operating principle of the present disclosure will be described with reference to FIGS. 3 to 6C.

FIG. 3 shows AM-PM characteristics of the first embodiment when there are not variations in the inter-stage capacitances C0 and C1. The phase (Phase) decreases with an increase in the output power (Pout), which is a characteristic feature. A reason why the phase decreases is that, as the Pout increases, the operation modes of the intermediate stage 11 and the rear stage 12 are changed from linearity to saturation. Also, the AM-PM characteristics have a significant influence on distortion, which is an important characteristic for amplifiers. When an amplifier is mass-produced, the AM-PM characteristics are used as standard data to set mass-production specifications. Therefore, it is desirable that the AM-PM characteristics should not deviate from the standard data.

FIG. 4 shows a graph which is obtained by adding, to the standard data graph of FIG. 3, AM-PM characteristics which are obtained when there are variations in the inter-stage capacitances C0 and C1. When there are positive variations in the inter-stage capacitances C0 and C1 (i.e., the inter-stage capacitances C0 and C1 increase), the amounts of input to the intermediate stage 11 and the rear stage 12 increase, and therefore, the intermediate stage 11 and the rear stage 12 are more likely to operate in the saturation mode than when there are not variations in the inter-stage capacitances C0 and C1. Therefore, the AM-PM characteristics have large phase changes as compared to standard samples (there are not variations). On the other hand, when there are negative variations in the inter-stage capacitances C0 and C1 (i.e., the inter-stage capacitances C0 and C1 decrease), the amounts of input to the intermediate stage 11 and the rear stage 12 decrease, and therefore, the intermediate stage 11 and the rear stage 12 are more likely to operate in the linear mode than when there are not variations in the inter-stage capacitances C0 and C1. Therefore, the AM-PM characteristics have small phase changes as compared to the standard samples.

Therefore, when the amplifier is operated where Pout=P1, then if there is a large difference (ΔA1 and ΔB1 in FIG. 4) between standard sample characteristics, and sample characteristics which are obtained when there are variations in the inter-stage capacitances C0 and C1, the stability of mass-production is degraded as described above. In other words, it is necessary to reduce the difference.

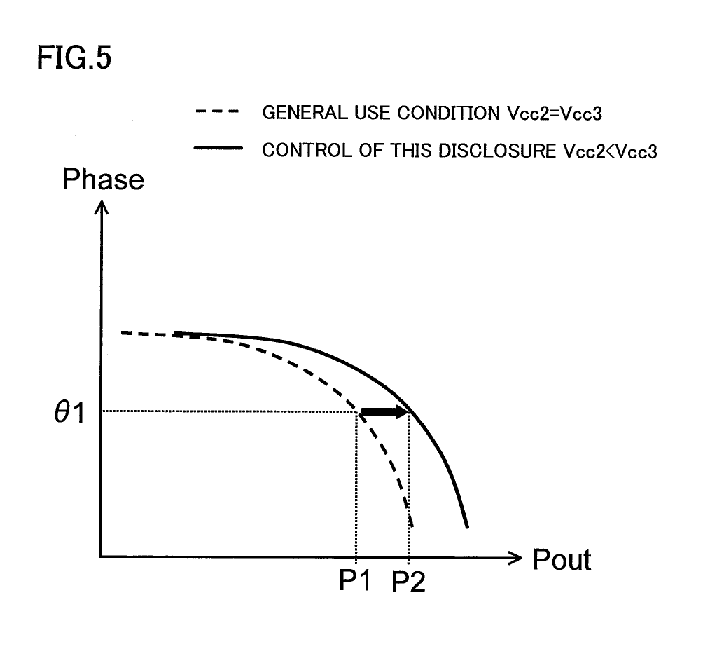

FIG. 5 is a graph showing an effect of the control of the present disclosure on the AM-PM characteristics. As can be seen from FIG. 5, the AM-PM characteristics are shifted in the positive direction of the Pout axis according to the control of the present disclosure (Vcc2<Vcc3) as compared to those under the general use condition (Vcc2=Vcc3). Note that this behavior has been confirmed by data obtained by actual measurement.

In FIG. 5, the value of the output power Pout at Phase=θ1 under the general use condition is compared with that during the control of the present disclosure. As can be seen, a target value (θ1) can be obtained at a lower Pout (P1) under the general use condition. This is because the bias voltage of the intermediate stage 11 is invariably lower during the control of the present disclosure than that under the general use condition, and therefore, saturation essentially becomes lower. Therefore, whereas the value θ1 is obtained at Pout=P1 under the general use condition, a value (P2) which is larger than that under the general use condition is required to obtain the value θ1 during the control of the present disclosure in which saturation is less likely to occur.

Note that it may be considered that the output power Pout is controlled where Vcc2>Vcc3 (e.g., Vcc3=3.3 V). In this case, however, the larger value Vcc2 increases the input power to the rear stage 12, resulting in enhancement of saturation of the rear stage 12. Therefore, the AM-PM characteristics are translated in a direction opposite to that of FIG. 5 where Vcc2<Vcc3, which is not appropriate.

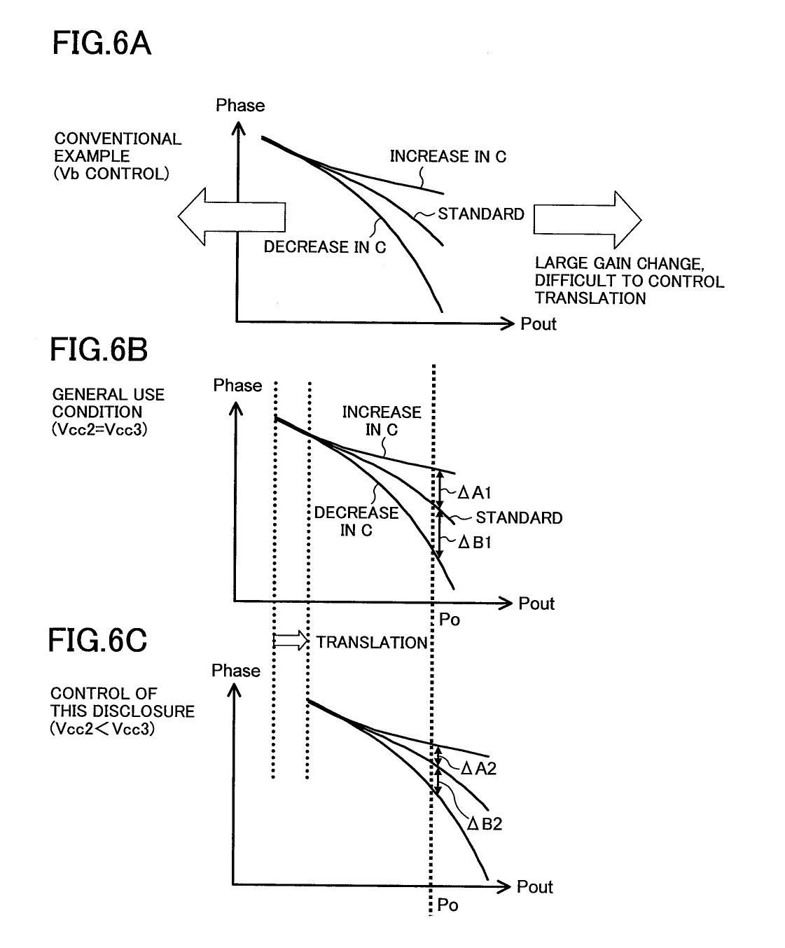

FIGS. 6A, 6B and 6C show a principle of suppression of variations in the AM-PM characteristics in this embodiment.

FIG. 6A shows a behavior which is expected when the Vb control disclosed in U.S. Pat. No. 6,603,351 is performed. As described above, the Vb control has a large gain change, and therefore, it is difficult to perform the translation control of the AM-PM characteristics, so that variations in the AM-PM characteristics cannot be appropriately suppressed.

FIG. 6B shows a case under the general use condition (Vcc2=Vcc3). As described above, when Pout=P0, then if there are positive variations in an inter-stage capacitance C, the AM-PM characteristics change by ΔA1, and then if there are variations in the inter-stage capacitance C, the AM-PM characteristics change by ΔB1.

In contrast to this, in the case of the control of the present disclosure shown in FIG. 6C (Vcc2<Vcc3), the AM-PM characteristics are translated according to the principle of

FIG. 5. Therefore, when Pout=P0, the AM-PM characteristics change by ΔA2 (<ΔA1) and ΔB2 (<ΔB1) in the respective aforementioned cases, i.e., variations in the AM-PM characteristics are suppressed.

As described above, according to the first embodiment, by setting the value of the multiplier 60 so that the voltage of the intermediate stage 11 is lower than the voltage of the rear stage 12, variations in the AM-PM characteristics which occur when there are variations in a device parameter (particularly, an inter-stage capacitance) can be suppressed, so that the distortion characteristics can be improved.

### Second Embodiment

In a second embodiment, a difference between the first and second embodiments will be mainly described. The other configurations, operations and effects are similar to those of the first embodiment and will not be described.

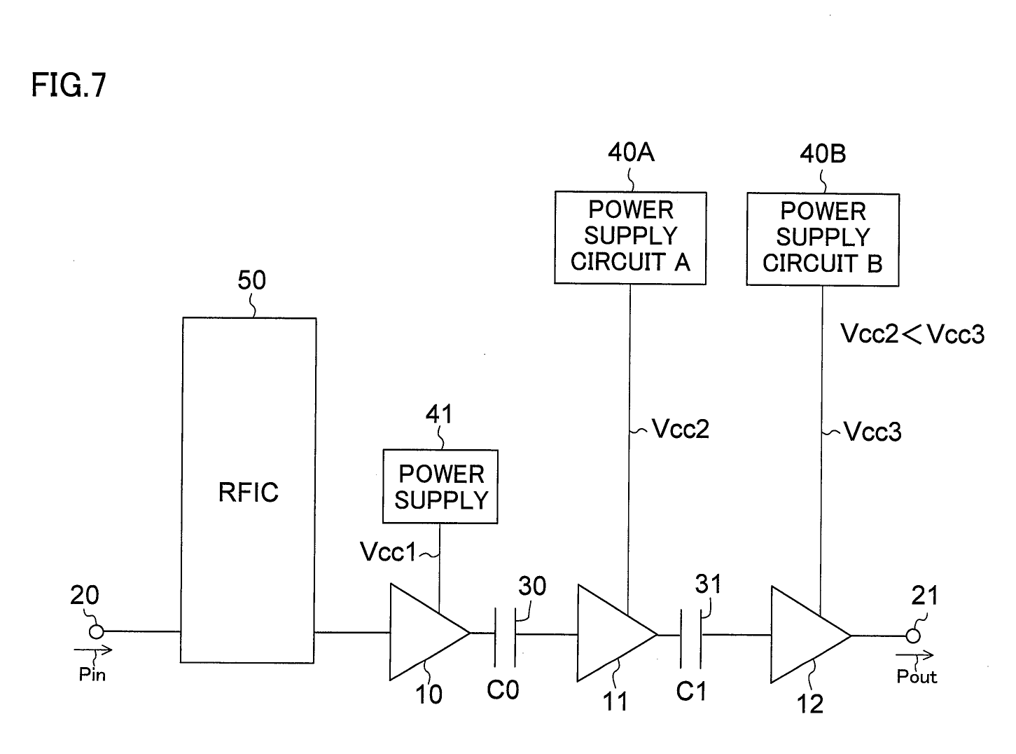

FIG. 7 is a block diagram showing a radio frequency circuit according to the second embodiment. The second embodiment is obtained by connecting a first power supply circuit 40A and a second power supply circuit 40B to the intermediate stage 11 and the rear stage 12, respectively, in the first embodiment. The first power supply circuit 40A supplies a control voltage Vcc2 to the intermediate stage 11, and the second power supply circuit 40B supplies a control voltage Vcc3 to the rear stage 12. Here, it is assumed that Vcc2<Vcc3.

By using the separate power supply circuits 40A and 40B, the voltage of the intermediate stage 11 and the voltage of the rear stage 12 are set so that the former is also lower than the latter in this embodiment. As a result, variations in the AM-PM characteristics which occur when there are variations in a device parameter (particularly, an inter-stage capacitance), can be suppressed, so that the distortion characteristics can be improved.

### Third Embodiment

In a third embodiment, a difference between the first and third embodiments will be mainly described. The other configurations, operations and effects are similar to those of the first embodiment and will not be described.

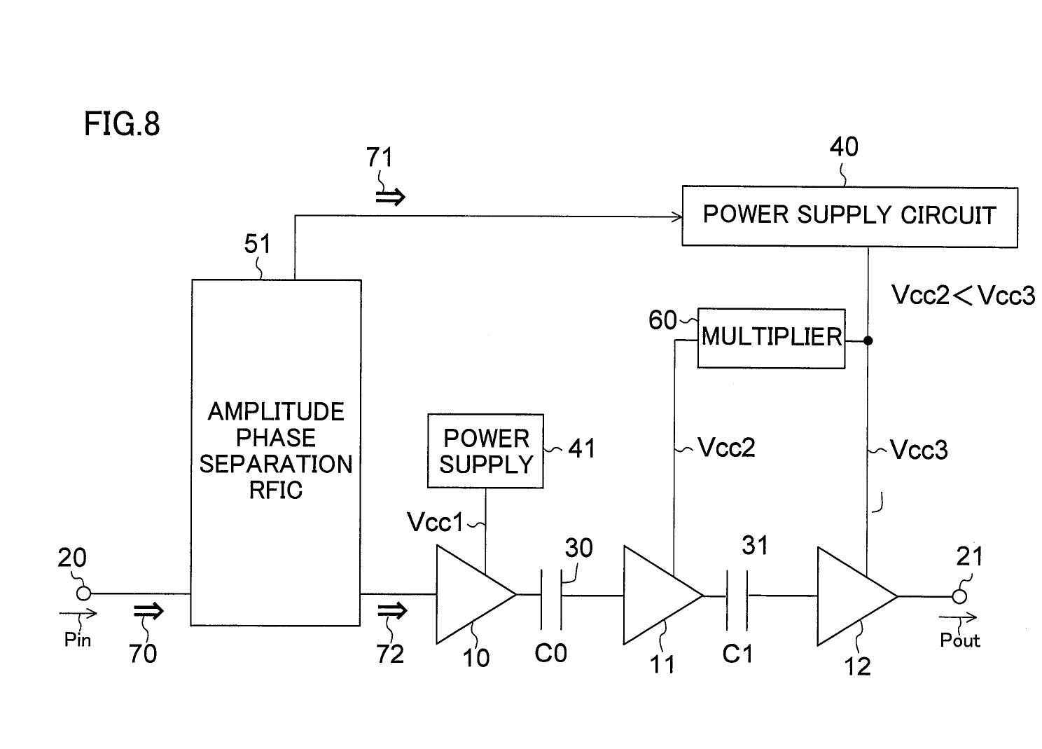

FIG. 8 is a block diagram showing a radio frequency circuit according to the third embodiment. The third embodiment is obtained by providing an RFIC 51 for separating an amplitude and a phase instead of the modulation RFIC 50 in the first embodiment. An input signal 70 supplied through the input terminal 20 is separated into an amplitude signal 71 and a phase signal 72 by the RFIC 51. The amplitude signal 71 is supplied to the power supply circuit 40, and the phase signal 72 is supplied to the front stage 10 of the multi-stage amplifier.

By setting the value of the multiplier 60 so that the voltage of the intermediate stage 11 is lower than the voltage of the rear stage 12 (i.e., Vcc2<Vcc3) as in the first embodiment, variations in the AM-PM characteristics which occur when there are variations in the inter-stage capacitances C0 and C1, can be suppressed.

Thus, according to the third embodiment, it is possible to suppress variations in the

AM-PM characteristics which occur when there are variations in a device parameter (particularly, an inter-stage capacitance) with respect to the phase signal 72. This embodiment is a technique applicable to, for example, polar modulation, which is expected as a next-generation modulation technique.

### Fourth Embodiment

In a fourth embodiment, a difference between the third and fourth embodiments will be mainly described. The other configurations, operations and effects are similar to those of the third embodiment and will not be described.

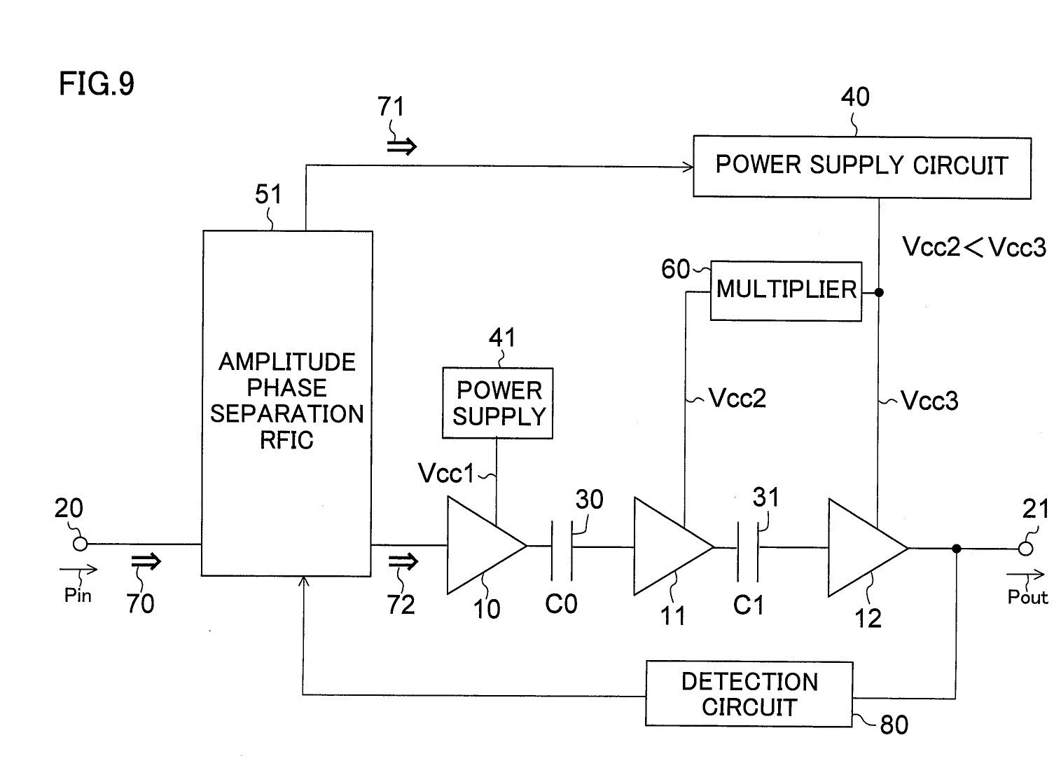

FIG. 9 is a block diagram showing a radio frequency circuit according to the fourth embodiment. The fourth embodiment is obtained by providing a detection circuit 80 between the output terminal 21 and the amplitude phase separation RFIC 51 in the third embodiment.

As described above, when there are positive variations in the inter-stage capacitances C0 and C1, the amount of input to the intermediate stage 11 and the rear stage 12 increase, and therefore, the output power and the output current increase. When there are negative variations in the inter-stage capacitances C0 and C1, an opposite phenomenon causes the output power and the output current to decrease. This relationship is shown in

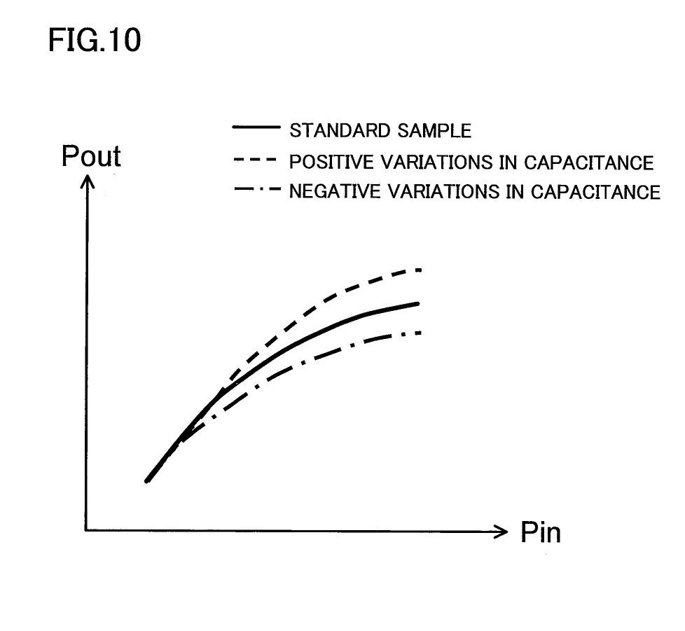

FIG. 10. The horizontal axis represents input power Pin, and the vertical axis represents output power Pout. As can be seen from FIG. 10, variations in the inter-stage capacitances C0 and C1 can be estimated by detecting a change in the output power or the output current.

In this embodiment, if the detection circuit 80 detects a change in the output power Pout which occurs when there are variations in a device parameter (particularly, a capacitance), a signal which can be used to set the value of the multiplier 60 so that the voltage Vcc2 of the intermediate stage 11 is lower than the voltage Vcc3 of the rear stage 12, is input to the power supply circuit 40. As a result, it is possible to suppress variations in the AM-PM characteristics which occur when there are variations in the inter-stage capacitances C0 and C1.

The detection circuit 80 is used to detect a change in the output power Pout, and typically includes a diode. Also, the detection circuit 80 may be connected to and provided immediately after the intermediate stage 11 so as to detect a change in the output power of the intermediate stage 11. Also, when there are variations in the inter-stage capacitances C0 and C1, there are also variations in the currents of the power supply circuit 40 supplied to the intermediate stage 11 and the rear stage 12. Therefore, the detection circuit 80 may be connected to a terminal of the power supply circuit 40 so as to detect a change in the current of the power supply circuit 40.

As described above, according to the fourth embodiment, the control method of the present disclosure is employed when the detection circuit 80 detects variations in a device parameter (particularly, an inter-stage capacitance), thereby making it possible to suppress variations in the AM-PM characteristics with respect to the phase signal 72. Moreover, this embodiment is a technique applicable to, for example, polar modulation, which is expected as a next-generation modulation technique.

### Fifth Embodiment

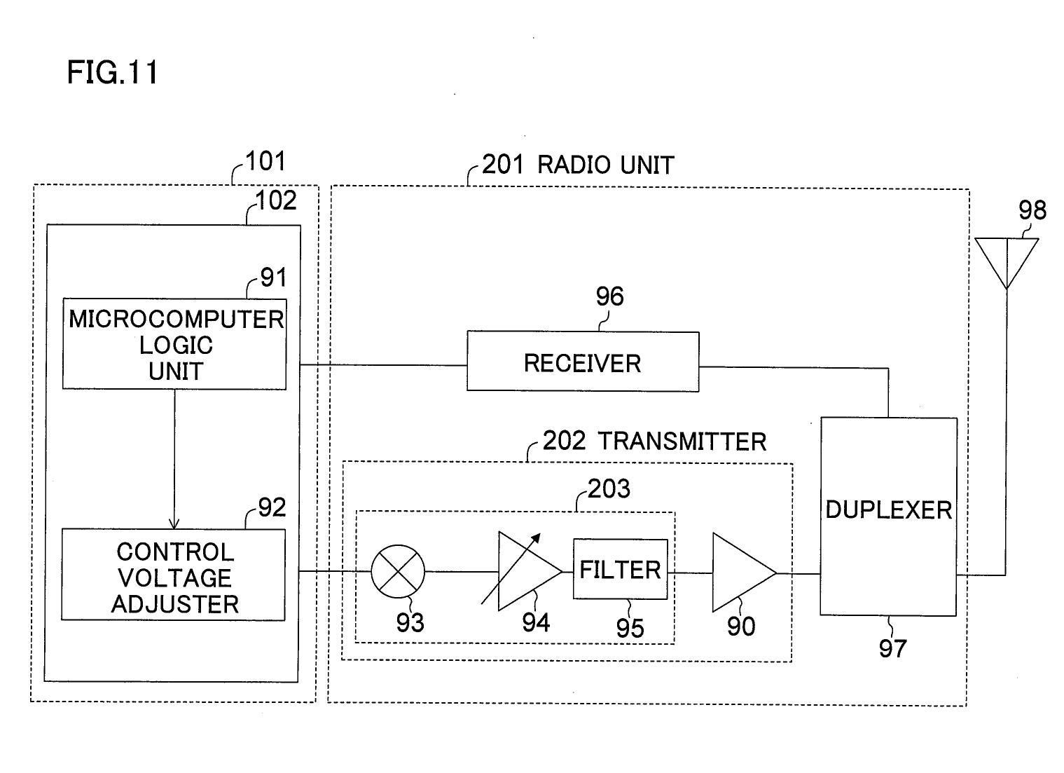

FIG. 11 is a block diagram showing a configuration of a mobile communication terminal device according to a fifth embodiment. The mobile communication terminal device is used in a mobile communication method, such as W-CDMA or the like, which needs to control a transmission output level within the range of −53 dBm to +27 dBm (80 dB). The mobile communication terminal device includes a radio unit 201 which generates transmission and reception signals, and a baseband unit 101. The radio unit 201 includes a receiver 96, a transmitter 202, and a duplexer 97 for an antenna 98. The baseband unit 101 includes a controller 102 having a microcomputer logic unit 91 and a control voltage adjuster 92. The baseband unit 101 controls the receiver 96 and the transmitter 202, performs an audio process, or the like. The control voltage adjuster 92 generates a control voltage and a reference voltage for controlling the components included in the radio unit 201 from a voltage supplied from a power supply (not shown), such as a lithium battery or the like, based on a command signal output from the microcomputer logic unit 91.

The transmitter 202 includes an intermediate frequency unit 203 which generates a signal to be transmitted to a base station, and an amplifier 90 which amplifies the signal generated by the intermediate frequency unit 203 to a desired amplitude. The amplifier 90 is assumed to be the radio frequency circuit of the first or second embodiment.

The intermediate frequency unit 203 includes a mixer 93, a variable gain amplifier 94, and a filter 95. An audio signal output from the controller 102 is frequency-converted by the mixer 93, and is amplified by the variable gain amplifier 94. A gain of the variable gain amplifier 94 can be adjusted by adjusting a magnitude of a gain control voltage. The filter 95 passes only a signal having a predetermined frequency of the output of the variable gain amplifier 94.

As described above, according to the fifth embodiment, it is possible to suppress variations in the AM-PM characteristics which occur when there are variations in a device parameter (particularly, an inter-stage capacitance) of the amplifier 90, whereby a mobile communication terminal device which can improve the distortion characteristics can be provided.

Note that a semiconductor device in which at least a portion of a plurality of amplification stages constituting the amplifier 90 of FIG. 11 is implemented as a semiconductor chip, can be employed.

In all of the aforementioned embodiments, each stage of the multi-stage amplifier includes a bipolar transistor, or alternatively, may include other transistors, such as a heterojunction bipolar transistor, a silicon germanium transistor, a FET, an Insulated Gate Bipolar Transistor (IGBT), and the like. Moreover, each stage may include a single transistor or a plurality of transistors. Moreover, each stage may have a multi-stage configuration. When these transistors are used to provide the front stage 10, the intermediate stage 11 and the rear stage 12, their emitters or sources are typically grounded. In this case, the input terminal is a base terminal or a gate terminal, the output terminal is a collector terminal or a drain terminal, and the common terminal is an emitter terminal or a source terminal.

Note that the components of the aforementioned embodiments may be combined in any manner that does not depart from the scope of the present disclosure.

The embodiments described above are all only for illustrating the present disclosure and are not to be construed as limiting the present disclosure. Those skilled in the art can easily contemplate various example configurations using the technique of the present disclosure.

Note that the present disclosure is applicable to a radio frequency circuit, a semiconductor device, and a radio frequency power amplifier.

What is claimed is:

1. A radio frequency circuit comprising:
a plurality of amplification stages connected in a cascade fashion; and
a power supply unit configured to control an output voltage of a final stage of the plurality of amplification stages and an output voltage of a stage immediately preceding the final stage of the plurality of amplification stages,
wherein the output voltage of the stage immediately preceding the final stage is set to be smaller than the output voltage of the final stage.

2. The radio frequency circuit of claim 1, wherein
the power supply unit includes:
a power supply circuit configured to control the final stage; and
a multiplier provided between the power supply circuit and the stage immediately preceding the final stage.

3. The radio frequency circuit of claim 1, wherein
the power supply unit includes:
a first power supply circuit configured to control the stage immediately preceding the final stage; and
a second power supply circuit configured to control the final stage.

4. The radio frequency circuit of claim 2, further comprising:
a modulation circuit configured to separate an input signal into an amplitude signal and a phase signal, the modulation circuit preceding the plurality of amplification stages,
wherein the amplitude signal is input to the power supply circuit.

5. The radio frequency circuit of claim 4, further comprising:
a circuit configured to detect output power of the final stage or the stage immediately preceding the final stage.

6. The radio frequency circuit of claim 4, further comprising:
a circuit configured to detect an output current of the final stage or the stage immediately preceding the final stage.

7. The radio frequency circuit of claim 1, wherein
the plurality of amplification stages each include a bipolar transistor, and
the power supply unit controls a collector voltage of the final stage of the plurality of amplification stages and a collector voltage of the stage immediately preceding the final stage.

8. A semiconductor device, wherein
a portion of the plurality of amplification stages in the radio frequency circuit of claim 1 is implemented as a semiconductor chip.

9. A mobile communication terminal device comprising:
the radio frequency circuit of claim 1.
